(19) United States
(12) Patent Application Publication
(10) Pub. No.: US 2007/0251112 A1
(43) Pub. Date: Nov. 1, 2007

(54) IRRIGATION CONTROLLER MOUNTING TEMPLATE

(75) Inventors: Ralf San Jose, Chula Vista, CA (US); Douglas C. Stewart, Wichita, KS (US)

Correspondence Address: FITCH EVEN TABIN AND FLANNERY, 120 SOUTH LA SALLE STREET, SUITE 1600, CHICAGO, IL, 60603-3406, US

(73) Assignee: Rain Bird Corporation, Glendora, CA (US)

(21) Appl. No.: 11/380,314

(22) Filed: Apr. 26, 2006

(51) Int. Cl. B43L 7/00

(52) U.S. Cl. 33/566

(57) ABSTRACT

A template for mounting a plurality of different of irrigation controllers models in accordance with one embodiment comprising a template support body; and a plurality of sets of apertures in said template support body, the plurality of sets of apertures corresponding to locations for fastening mounting supports to a mounting structure, each of the set of apertures corresponding to a different model irrigation controller.

### BACKGROUND OF THE INVENTION

1. Field of the Invention

The present invention relates to mounting irrigation controllers. More specifically, the present invention relates the mounting of a plurality of differently sized irrigation controllers.

2. Discussion of the Related Art

Irrigation controllers are generally mounted on a wall or other flat vertical mounting surface. The irrigation controller includes mounting holes located either on a back side of the irrigation controller or the back side of an irrigation controller box. Generally, screws or other types of mounting supports are fastened to the wall. The screws are fastened to the wall such that the mounting holes on the back of the controller line up with the screws. The irrigation controller is then hung from the screws and stays securely against the wall. Optionally, a final mounting screw is also fastened through a back side of the irrigation controller after the irrigation controller has been hung in order to fasten the irrigation controller to the wall such that it can not be removed without removing the final mounting screw. In this manner, the irrigation controller can not be accidentally knocked off of the wall or taken down without removing the final mounting screw.

There are a couple of known methods for helping an installer of the irrigation controller to properly fasten the screws to the wall such that the mounting holes on the back side of the irrigation controller will line up with the screws after the screws have been fastened to the wall. One method is to measure the distances between the holes on the back of the irrigation controller and then make corresponding measurements on the wall in order to determine the proper positioning of the screws. This can be time consuming and prone to mistakes as the location of the screws needs to be fairly accurate or the irrigation controller will not mount properly.

Another solution is to provide a paper or cardboard template that comes with the packaging of the irrigation controller. The template will include markings that show the proper positioning for the screws for the specific irrigation controller that was shipped with the template. An installer holds the paper or cardboard template against the wall and either marks the wall and then fastens the screws to the wall in the locations that were marked or fastens the screws directly to the wall when the template is being held against the wall. Once the screws are fastened to the wall, the irrigation controller is mounted on the screws. The template gives the installer an accurate and easy to use installation method. However, a new template will generally be used for each irrigation controller that needs to be installed and the template generally can only be used with one model of irrigation controller. Additionally, the installer can have problems making sure that the paper template is held level while marking the wall. This can lead to an irrigation controller that does not look good after being installed.

In yet another installation method, when the irrigation controller is mounted within an irrigation controller box, the irrigation controller can be removed or partially removed from the irrigation controller box. Removal of the irrigation controller exposes the holes in the back of the irrigation controller box. An installer can then fasten screws to the wall through the holes in the back of the irrigation controller box. Optionally, as described above, the installation procedure can be a combination of hanging the irrigation controller on screws and fastening the screws to the wall through the holes in the back of the irrigation controller box. Once completed, the irrigation controller box will be mounted on the wall and the irrigation controller can be place back into the irrigation controller box. While, this method removes the need for any tools (i.e., a measuring device or template), it is not always easy or possible to remove the irrigation controller from the irrigation controller box. Furthermore, some irrigation controllers do not include an irrigation controller box and thus, can not be mounted in the manner.

### SUMMARY OF THE INVENTION

Described herein are various embodiments of a template for aiding in the mounting of a plurality of different models of irrigation controllers.

One embodiment can be characterized as a template for mounting a plurality of different of irrigation controllers models comprising a template support body; and a plurality of sets of apertures in said template support body, the plurality of sets of apertures corresponding to locations for fastening mounting supports to a mounting structure, each of the set of apertures corresponding to a different model irrigation controller.

Another embodiment can be characterized as a method for mounting an irrigation controller comprising utilizing a template to create marks on a mounting surface, the marks for indicating a position for fastening a plurality of mounting supports for the irrigation controller to a mounting surface, wherein the template includes a template support body; and a plurality of sets of apertures in said template support body, the plurality of sets of apertures corresponding to locations for fastening mounting supports to a mounting structure, each of the set of apertures corresponding to a different model irrigation controller; and mounting said irrigation controller on the plurality of mounting supports.

A subsequent embodiment includes a method of mounting an irrigation controller comprising placing a mounting template in contact with a mounting surface; determining from a plurality of sets of apertures, a set of apertures in the mounting template that corresponds to the irrigation controller to be mounted on the mounting surface, the plurality of sets of apertures corresponding to a plurality of different models of irrigation controllers; and creating marks on the mounting surface through the set of apertures in the mounting template that correspond to the irrigation controller to be mounted, the marks for indicating a position for a plurality of mounting supports to be fastened to the mounting surface.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram illustrating a front view of a template for mounting a plurality of different model irrigation controllers in accordance with one embodiment;

FIG. 2 is a diagram illustrating a three dimensional view of the template of FIG. 1;

FIG. 3 is a diagram illustrating a plurality of different model irrigation controllers and a template for mounting the plurality of different model irrigation controllers in accordance with one embodiment; and

FIG. 4 is a diagram illustrating a back side of an irrigation controller box in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

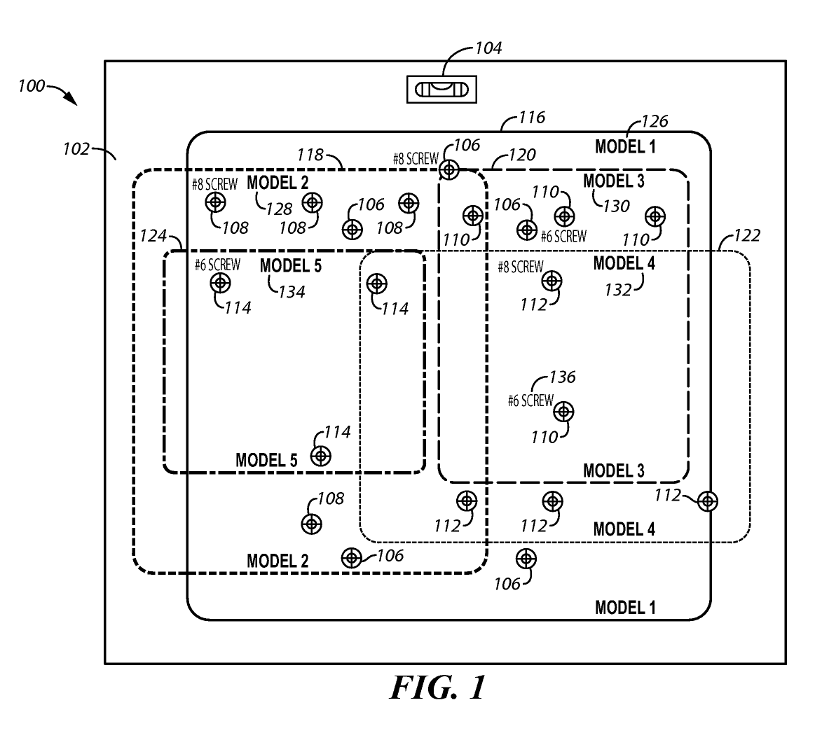

Referring to FIG. 1, a diagram is shown illustrating a front view of a mounting template 100 for mounting a plurality of different irrigation controllers in accordance with one embodiment. Shown is a template support body 102, a level 104, a first set of apertures 106, a second set of apertures 108, a third set of apertures 110, a fourth set of apertures 112, a fifth set of apertures 114, a first controller outline 116, a second controller outline 118, a third controller outline 120, a fourth controller outline 122, a fifth controller outline 124, a first model indicator 126, a second model indicator 128, a third model indicator 130, a fourth model indicator 132, a fifth model indicator 134, and a mounting support type indicator 136.

The mounting template 100 is used, for example, by contractors or other irrigation controller installers to aid in the installation of a plurality of different models of irrigation controllers, each model generally being differently sized or having a different arrangement of mounting hole locations. Generally, a contractor will be installing a number of different models of irrigation controllers for various customers. The mounting template 100 described herein, in some embodiments, provides a durable, light weight, reusable, mounting template that can be used with a plurality of different models of irrigation controllers. Advantageously, this allows the contractor to readily have a mounting template available for installation of an irrigation controller so long as the model of the irrigation controller corresponds to one of the plurality of sets of apertures in the mounting template 100.

The first set of apertures 106, the second set of apertures 108, the third set of apertures 110, the fourth set of apertures 112, and the fifth set of apertures 114 (also collectively referred to herein as the plurality of sets of apertures) are formed in the template support body 102 and each correspond to locations for fastening mounting supports (e.g., screws) in a mounting surface (e.g., a wall) for a particular irrigation controller. The mounting template 100 is held against the mounting surface and the locations for fastening the mounting supports are marked using one of the plurality of sets of apertures (e.g., the first set of apertures 106). The mounting supports, once fastened to the mounting surface, are used to mount the irrigation controller. That is, the irrigation controller is hung on the mounting surface from the mounting supports. Each one of the plurality of sets of apertures defines locations for fastening mounting supports that correspond to a different model irrigation controller.

In the illustrated embodiment, each of the plurality of sets of apertures includes an aperture that is horizontally offset from another aperture. Additionally, each of the plurality of sets of apertures includes an aperture that is vertically offset from another aperture.

Optionally, located on a front side of the mounting template 100 are the first controller outline 116, the second controller outline 118, the third controller outline 120, the fourth controller outline 122, and the fifth controller outline 124 (also collectively referred to herein as a plurality of controller outlines). Each of the plurality of controller outlines is associated with one of the plurality of sets of apertures. For example, the first controller outline 116 is associated with the first set of apertures 106. The first controller outline 116 is approximately the same size as the model of irrigation controller that the first set of apertures 106 corresponds to. This provides a guide to an irrigation installer who is using the mounting template 100 as the plurality of controller outlines can be compared to the current irrigation controller that the irrigation installer is going to mount. The irrigation installer can compare the shape of the current irrigation controller to the shapes of the plurality of controller outlines. After determining which controller outline corresponds to the current model irrigation controller, the set of apertures that corresponds to the determined controller outline can be used to mark the locations for the mounting supports that will be used to mount the irrigation controller.

The mounting template optionally includes the first model indicator 126, the second model indicator 128, the third model indicator 130, the fourth model indicator 132, and the fifth model indicator 134 (also collectively referred to herein as the plurality of model indicators). Each of the plurality of model indicators corresponds to one of the plurality of set of apertures and one of the plurality of controller outlines. The first model indicator 126 is, for example, the name of the model of irrigation controller that is associated with the first set of apertures 106. The model indicators can be any combination of letters, numbers and symbols that identifies the model of the irrigation controller and is illustrated as “Model X.” The plurality of model indicators give additional information to an installer as to which one of the plurality of sets of apertures should be used with a specific model of irrigation controller. Each of the model indicators can refer to a specific model irrigation controller or to a class of irrigation controllers. Thus, each set of apertures may be used for one specific irrigation controller or a plurality of irrigation controllers within a class.

In one embodiment, the plurality of sets of apertures, the plurality of controller outlines, and the plurality of model indicators are color coded in order to further indicate to an installer the set of apertures that is to be used with the specific model irrigation controller that is being installed. For example, the first set of apertures 106 will include blue markings around each of the holes in the first set of apertures 106. In this manner, the first set of apertures is designated blue. Additionally, the first controller outline 116 and the first model indicator 126 will both be printed in the color blue. In this manner, the first controller outline 116 and the first model indicator 126 are clearly associated with the first set of apertures 106. Similarly, the second set of apertures 108 will include yellow markings around each of the holes in the second set of apertures 108. Additionally, the second controller outline 118 and the second model indicator 128 will both be printed in the color yellow. In this manner, the second controller outline 118 and the second model indicator 128 are clearly associated with the second set of apertures 108. Different colors can then be utilized for the remainder of the sets of apertures, controller outlines and model indicators.

As described above, each one of the plurality of sets of apertures define locations for fastening mounting supports to a mounting surface, where each set of apertures corresponds to a different model irrigation controller. For example, when in use the mounting template 100 is placed against the mounting surface by an installer. The first set of apertures 106 defines the locations for fastening five mounting supports to the mounting surface. The five mounting supports correspond to a first model of irrigation controller that has five mounting holes located on a back side of the first model of irrigation controller. The holes are either located directly in the back of the irrigation controller or in an irrigation controller box that houses the irrigation controller. After the mounting supports are fastened to the mounting surface the first model of irrigation controller can be hung from the mounting supports. Similarly, the second set of apertures 108 define four locations for fastening four mounting supports in a mounting surface that correspond to a second model of irrigation controller that has four mounting holes located on a back side of the second model of irrigation controller. In this manner, each of the plurality of sets of apertures defines a different hole pattern that corresponds to different locations for mounting a plurality of mounting supports to a mounting surface.

Optionally included next to one or more of the apertures is the mounting support type indicator 136. The mounting support type indicator 136 informs the installer of the irrigation controller the type of mounting support that should be used for the specific model irrigation controller associated with the set of apertures. For example, the mounting support type indicator 136 can indicate the size of screw (e.g., #6 screw or #8 screw) that should be used to mount the specific model irrigation controller. In this manner, the proper mounting support to be used for different models of irrigation controllers in indicated on the mounting template 100.

Additionally, in some embodiments, the level 104 is secured to the front side of the template support body 102. The level 104 is secured to or otherwise integrated with the template support body 102 with glues, small nails, small screws, or other known securing means. The level 104 is used to indicate to an irrigation installer that the mounting template is correctly aligned before marking locations for fastening mounting supports to a mounting surface. Having the locations for the mounting supports correctly aligned ensures the irrigation controller will be mounted properly. Advantageously, because the irrigation controller is one of the only parts of an irrigation system that is readily visible by a user of the irrigation controller, the level 104 helps to ensure the irrigation controller is mounted properly and does not look improperly installed to the user.

In one embodiment, a trouble shooting guide for one or more of the irrigation controllers the template is designed for is located on a back side of the mounting template 100. Advantageously, this provides an irrigation controller installer with a single device that can be used for mounting a plurality of different model irrigation controllers and also aids the irrigation controller installer with trouble shooting any problems that occur during installation, operation, or maintenance of any of the models of irrigation controllers.

When a contractor or irrigation installer utilizes the mounting template 100, the following process will generally be followed in accordance with one embodiment. First, the contractor will determine the model of irrigation controller that is to be mounted on a wall or other mounting surface. Next, the contractor will determine which set of apertures corresponds to the irrigation controller. As described above, the mounting template optionally includes the controller outlines and the model indicators to aid the contractor in make the determination. Next, the contractor will determine where on the wall the irrigation controller is going to be mounted. The mounting template 100 is then held against the wall. The level 104 can be used to ensure the mounting template 100 is being held level to the ground.

Following, the contractor will mark the mounting surface through each of apertures in the set of apertures that corresponds to the irrigation controller that is being installed. The marks correspond to the location on the mounting surface where a plurality of mounting supports will be fastened to the mounting surface. The contractor can mark the mounting surface by using a writing apparatus (e.g., a pencil or pen) to create marks. Alternatively, the contractor or irrigation installer can push a hard object through the apertures and into the mounting surface to mark the mounting surface. In another alternative, in order to mark the mounting surface the contractor drills a hole through the aperture in order to create a small starter hole for a mounting support (e.g., a screw) that is later fastened to the wall. Still alternatively, in one embodiment, the contractor can mark the mounting surface by fastening the mounting supports to the wall directly through the apertures in the mounting template 100. In this embodiment, the apertures are large enough such that the mounting supports can fit entirely through the apertures, allowing the template to be removed after the mounting supports have been fastened to the mounting surface. In all of the above examples, the mounting surface becomes marked through one of the sets of apertures.

Next, the mounting template 100 is removed from the wall and if the mounting supports have not already been fastened to the mounting surface, the mounting supports will be fastened to the mounting surface at the locations that have been previously marked. Once the mounting supports are fastened to the mounting surface, the irrigation controller can be hung on the mounting supports. Advantageously, the mounting template 100 can be utilized for a plurality of different model irrigation controllers. This allows the mounting template 100 to be used from job to job by the contractor.

As shown in FIG. 1, the plurality of sets of apertures and the plurality of controller outlines overlap each other. For example, the first controller outline 116 overlaps each of the other of the plurality of controller outlines. However, not all of the plurality of controller outlines overlap all of the other of the controller outlines. For example, the fifth controller outline 124 does not overlap the third controller outline 120. Additionally, for example, the first set of apertures 106 overlaps each of the other of the plurality of sets of apertures. In this manner, the size of the mounting template 100 can be reduced as compared to a mounting template having each of the controller outlines side by side. Advantageously, having a smaller and lighter mounting template makes the mounting template more user friendly for contractors.

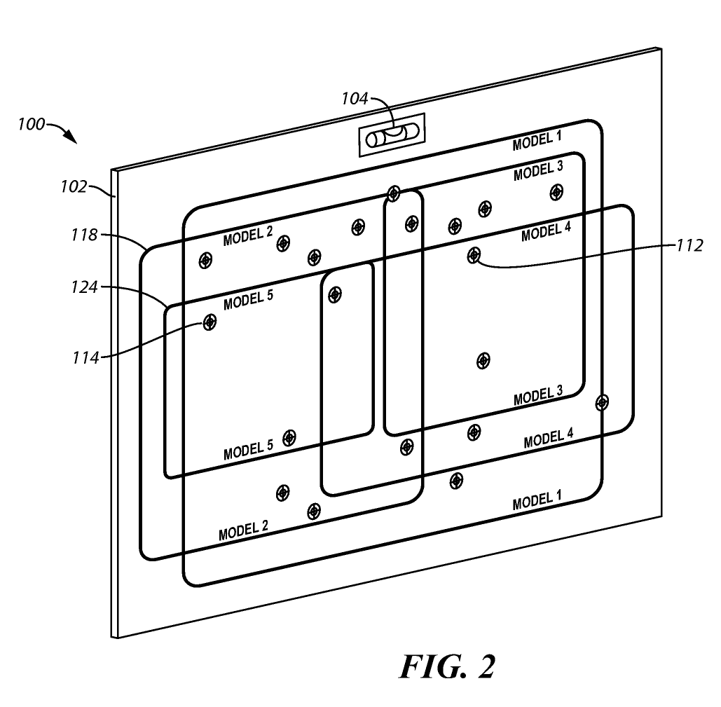

Referring to FIG. 2, a diagram is shown illustrating a three dimensional or perspective view of the template of FIG. 1. The template support body 102 is made from a rigid or semi-rigid material. In various embodiments, the template support body 102 is made from, for example, plastic, acrylic, or poster board. Preferably, the template support body 102 is made from a light, rigid material such that it is easy to carry around and hold against a mounting surface and is also durable so that it can be used multiple times. The template support body 102, as shown, is approximately ⅛ of an inch thick, however, various thicknesses can be used depending upon the strength of the material, the desired weight and the desired durability of the template.

In one embodiment, poster board is used for the template support body and the various markings (controller outlines, models indicators, mounting fixture type indicators) are printed onto a front side of the poster board with an optional laminate. Optionally, printed on a back side of the poster board is an installation and/or operation trouble shooting guide for one or more of the irrigation controllers for which the template is designed. Additionally, either before or after the printing, the sets of apertures are made in the poster board, for example, by drilling or punching out holes in the template support body 102.

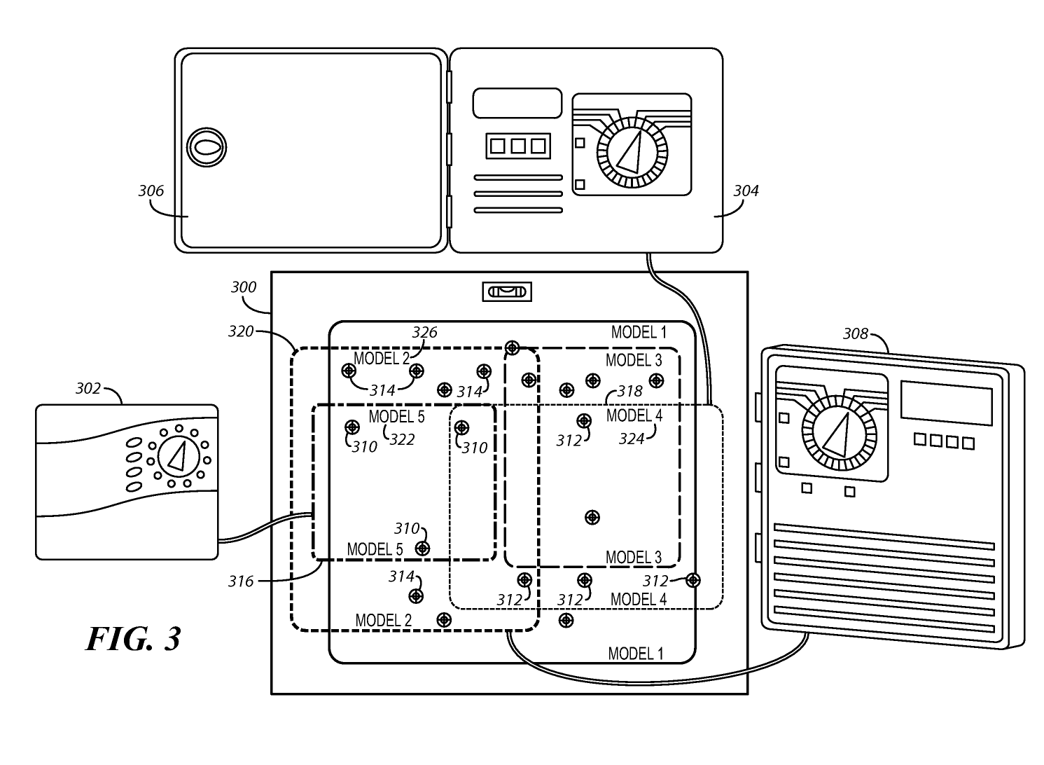

Referring now to FIG. 3, a diagram is shown illustrating a plurality of different irrigation controllers and a mounting template for mounting the plurality of different irrigation controllers in accordance with one embodiment. Shown is a template support body 300, a first irrigation controller 302, a second irrigation controller 304, an irrigation controller box lid 306, a third irrigation controller 308, a first set of apertures 310, a second set of apertures 312, a third set of apertures 314, a first controller outline 316, a second controller outline 318, a third controller outline 320, a first model indicator 322, a second model indicator 324, and a third model indicator 326. As illustrated, each of the irrigation controller models (302, 304, 308) is differently sized and has mounting holes in different orientations.

The first irrigation controller 302 corresponds to the first set of apertures 310 and the first controller outline 316. The first irrigation controller 302 is approximately the same size as the first controller outline 316. In this manner, an installer can easily associate the first irrigation controller 302 with the first controller outline 316 and the first set of apertures 310. The first irrigation controller 302 is a small controller that is not contained within an irrigation controller box. Thus, the first set of apertures 310 correspond to mounting holes (not shown) located directly on a back side of the first irrigation controller 302. The mounting template also optionally includes the first model indicator 322. The first model indicator 322 indicates to an installer the model of irrigation controller that corresponds to the first set of apertures 310. The first irrigation controller 302 is a specific model of irrigation controller and is further associated with the first set of apertures 310 through the first model indicator 322. That is, the model of irrigation controller is the same as the first model indicator 322.

Similarly, the second irrigation controller 304 corresponds to the second set of apertures 314 and the second controller outline 318. The second irrigation controller 304 is approximately the same size as the second controller outline 318. Additionally, the second irrigation controller 304 is a model of irrigation controller that is associated with the second model indicator 324. The second irrigation controller 304 includes an irrigation controller box and irrigation controller box lid 306. The irrigation controller box of the second irrigation controller 304 includes mounting holes (not shown) located on a back side of the irrigation controller box.

The third irrigation controller 308 corresponds to the third set of apertures 314, the third controller outline 320, and the third model indicator 326 in the same manner as described above with reference to the first irrigation controller 302 and the second irrigation controller 304.

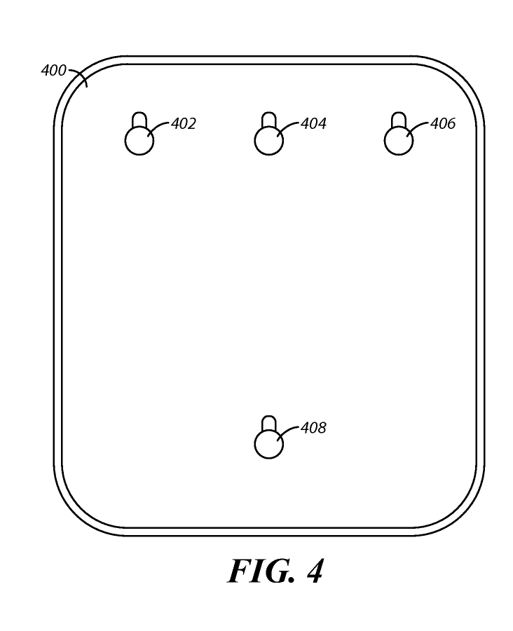

Referring to FIG. 4, a diagram is shown illustrating a back side of an irrigation controller in accordance with one embodiment. Shown is a controller mounting structure 400, a first mounting hole 402, a second mounting hole 404, a third mounting hole 406 and a fourth mounting hole 408.

The first mounting hole 402, the second mounting hole 404, the third mounting hole 406 and the fourth mounting hole 408 (also collectively referred to herein as a plurality of mounting holes) can be formed either directly in the irrigation controller or the irrigation controller box. As defined herein, in either embodiment, the plurality of mounting holes are formed in the controller mounting structure 400.

Once the mounting supports have been fastened to a mounting surface (e.g., a wall or post), the mounting supports fit into each of the plurality of mounting holes in the controller mounting structure. In this manner, the irrigation controller is mounted to the mounting surface.

In the embodiment shown, the plurality of mounting holes includes at least one mounting hole that is horizontally offset from another mounting hole. Additionally, the plurality of mounting holes includes at least one mounting hole that is vertically offset from another mounting hole. For example, the first mounting hole 402 is horizontally offset from the second mounting holes 404, 406, 408 and the first mounting hole 402 is vertically offset from the fourth mounting hole 408.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A template for mounting a plurality of different of irrigation controllers models comprising:
a template support body; and
a plurality of sets of apertures in said template support body, the plurality of sets of apertures corresponding to locations for fastening mounting supports to a mounting structure, each of the set of apertures corresponding to a different model irrigation controller.

2. The template of claim 1 further comprising a level coupled to said template support body.

3. The template of claim 1 wherein each of the plurality of sets of apertures includes a horizontally offset aperture and a vertically offset aperture.

4. The template of claim 1 wherein each set of said apertures is designated with a different color.

5. The template of claim 1 wherein said template support body is made from a rigid material.

6. The template of claim 1 further comprising a plurality of controller outlines, each of the plurality of controller outlines corresponding to one of the plurality of sets of apertures.

7. The template of claim 6 further comprising a plurality of model indicators, each of the plurality of model indicators corresponding to one of the plurality of sets of apertures.

8. The template of claim 7 further comprising a plurality of controller outlines, each of the plurality of controller outlines corresponding to one of the plurality of sets of apertures.

9. The template of claim 8 where the plurality of controller outlines, the plurality of sets of apertures, and the plurality of model indicators are color coded.

10. The template of claim 1 wherein at least one of the plurality of sets of apertures overlaps another one of the plurality of sets of apertures.

11. A method for mounting an irrigation controller comprising:
utilizing a template to create marks on a mounting surface, the marks for indicating a position for fastening a plurality of mounting supports for the irrigation controller to a mounting surface, wherein the template includes:
a template support body; and
a plurality of sets of apertures in said template support body, the plurality of sets of apertures corresponding to locations for fastening mounting supports to a mounting structure, each of the set of apertures corresponding to a different model irrigation controller; and
mounting said irrigation controller on the plurality of mounting supports.

12. The method of claim 11 further comprising determining which one of said plurality of sets of apertures corresponds to the irrigation controller to be mounted.

13. The method of claim 11 further comprising utilizing a level integrated with said template to position the template against the mounting surface.

14. The method of claim 11 wherein each of the plurality of sets of apertures includes a horizontally offset aperture and a vertically offset aperture.

15. The method of claim 11 wherein each set of said apertures is designated with a different color.

16. The method of claim 11 wherein said template support body is made from a rigid material.

17. The method of claim 11 wherein said template further comprises a plurality of controller outlines, each of the plurality of controller outlines corresponding to one of the plurality of sets of apertures.

18. The method of claim 11 wherein said template further comprises a plurality of model indicators, each of the plurality of model indicators corresponding to one of the plurality of sets of apertures.

19. The method of claim 11 wherein at least one of the plurality of sets of apertures overlaps another one of the plurality of sets of apertures.

20. A method of mounting an irrigation controller comprising:
placing a mounting template in contact with a mounting surface;
determining from a plurality of sets of apertures, a set of apertures in the mounting template that corresponds to the irrigation controller to be mounted on the mounting surface, the plurality of sets of apertures corresponding to a plurality of different models of irrigation controllers; and
creating marks on the mounting surface through the set of apertures in the mounting template that correspond to the irrigation controller to be mounted, the marks for indicating a position for a plurality of mounting supports to be fastened to the mounting surface.

21. The method of claim 20 further comprising:
affixing the plurality of mounting supports to the mounting surface; and
mounting the irrigation controller on the mounting supports.
